(19) United States
(12) Patent Application Publication
(10) Pub. No.: US 2013/0046639 A1
(43) Pub. Date: Feb. 21, 2013

(54) On-Line Community for Individual Players, Gaming Content Developers and Casino Operators

(71) Applicant: Justin M. Woodard, Las Vegas, NV (US)

(72) Inventor: Justin M. Woodard, Las Vegas, NV (US)

(21) Appl. No.: 13/495,994

(22) Filed: Jun. 13, 2012

Related U.S. Application Data
(60) Provisional application No. 61/496,165, filed on Jun. 13, 2011.

(51) Int. Cl. G06Q 30/02; G06Q 50/00

(52) U.S. Cl. 705/14.67

(57) ABSTRACT

An on-line community for individuals with similar interests to meet and play/discuss their favorite casino games and for casinos and individuals to negotiate terms and conditions of a gambling vacation is provided. Such an on-line community provides a location for gaming content developers to have on-line digital version of their casino games vetted by the individuals who would play the live version of the games on a casino floor and, also, have their games reviewed and purchased/leased by casino operators.

### FIELD OF THE INVENTION

Aspects of embodiments described herein apply to an on-line community for both individuals and casino operators to come together and negotiate the details of gaming vacations and create, play, discuss and purchase gaming content.

### BACKGROUND OF THE INVENTION

Social media sites have become wildly popular in our society through the use of web-based and mobile technologies to turn communication into interactive dialogue. There are numerous sites available on the Internet that are devoted to networking for both work and fun. However, to date, the sizeable gambling community is disproportionately underrepresented in both quality and quantity of social media sites. This underrepresentation holds true for sites devoted to individual gamblers, casino game developers and casino operators.

Moreover, in the gambling community, two forces are at work when it comes to planning and booking a vacation at a casino. On one hand, the casino properties seek to get players in the door of their properties while maximizing the impact of their comps, i.e., convert the dollar value of a comp directly into dollars wagered in the casino. On the other hand, players desire to leverage their gambling dollars at a casino property for additional non-gambling related benefits such as complimentary airfare, hotel rooms, show tickets and meals.

So, a need exists for an on-line community for individuals with similar interests to meet and play/discuss their favorite casino games and for casinos and individuals to negotiate terms and conditions of a gambling vacation. In addition, a need exists for an on-line community for gaming content developers to have on-line digital version of their casino games vetted by the individuals who would play the live version of the games on a casino floor and, also, have their games reviewed and purchased/leased by casino operators.

### BRIEF SUMMARY

In one embodiment, a computer implemented method for matching individual players and casino operators is provided. The method provides a computer generated interface for individual players and a location for storing information associated with said individual players in memory. In addition, the method provides a computer generated interface for casino operators and a location for storing information associated with said casino operators in memory. Continuing, the method provides a computer generated interface for an individual player to make a bid on a gambling vacation and transmits the bid to a central processing unit and storing said bid in memory. At some point thereafter, one method retrieves the bid from memory and provides the bid to a casino operator. A computer generated interface is then provided for a casino operator to make an offer in response to said bid. The offer is transmitted to a central processing unit and stored in memory. Finally, the offer is provided to the individual player for review.

### BRIEF DESCRIPTION OF THE DRAWINGS

FIG. 1 illustrates a schematic view of a typical hosting/access environment for implementing the present invention;

FIG. 2 illustrates an exemplary splash page returned when a user accesses the domain address of the present invention;

FIG. 2A illustrates an exemplary user home page returned when the user successfully enters a valid username and password;

FIG. 3 illustrates an alternate embodiment of the player home page of FIG. 2A;

FIG. 4 illustrates an exemplary bidding page communicated to the user's computer or PDA in response to a user selecting the bidding module on the home page;

FIG. 5 illustrates an exemplary player information page communicated to the user's computer or PDA in response to an individual user selecting the player information module on the home page;

FIG. 6 illustrates an exemplary forum page communicated to the user's computer or PDA in response to a user selecting the forums module on the home page;

FIG. 7 illustrates an exemplary chat room page communicated to the user's computer or PDA in response to a user selecting the chat option from anywhere in the website, including the forum area;

FIG. 8 illustrates an exemplary accept an offer page communicated to the user's computer or PDA in response to an individual user selecting the bidding module on the home page;

FIG. 9 illustrates an exemplary application for player rating page to be filled out by the individual user and communicated from the user's computer or PDA to the host server;

FIG. 10 illustrates an exemplary casino home page returned when the casino operator successfully enters a valid username and password;

FIG. 11 illustrates an exemplary open bids by players page communicated to the casino operator's computer or PDA in response to an operator selecting the open bids by player module on the home page;

FIG. 12 illustrates an exemplary offer page for a casino operator to submit an offer to an open bid from a user;

FIG. 13 illustrates an exemplary offers extended page communicated to the casino operator's computer or PDA in response to an operator selecting the offers extended module on the home page;

FIG. 14 illustrates an exemplary bid filter page communicated to the casino operator's computer or PDA in response to an operator selecting the bid filters module on the home page;

FIG. 15 illustrates an exemplary casino information page communicated to the casino operator's computer or 40 in response to the operator selecting the casino information module on the home page;

FIG. 16 illustrates an exemplary accepted offers page communicated to the casino operator's computer or PDA in response to the operator selecting the accepted offers module on the home page;

FIG. 17 illustrates an exemplary rate player page communicated to the casino operator's computer or PDA in response to the operator selecting the rate player module on the home page;

FIG. 18 illustrates an exemplary hosted games page communicated to a computer or PDA from server in response to an individual user, a casino operator or a gaming content developer selecting a hosted games module on a home page;

FIG. 19 illustrates an exemplary hosted game page for the gaming content associated with new casino game;

FIG. 20 illustrates a game play web page communicated to a computer or PDA from server in response to an individual user selecting the play the game option in the hosted game page;

### BRIEF DESCRIPTION

In the following description, numerous specific details are set forth, such as examples of specific shapes, components etc., in order to provide a thorough understanding of the present invention. It will be apparent, however, to one skilled in the art that the present invention may be practiced without these specific details. In other instances, well known components or methods have not been described in detail but rather in general terms in order to avoid unnecessarily obscuring the present invention. Thus, the specific details set forth are merely exemplary. The specific details may be varied from and still be contemplated to be within the spirit and scope of the present invention.

Reference to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others. In general terms, an algorithm is conceived to be a self-consistent sequence of steps leading to a desired result. The steps of an algorithm require physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. It is further contemplated within the scope of this invention that calculations can also be done mentally, manually or using processes other than electronic.

The present invention also relates to one or more apparatus for performing the operations herein. This apparatus may be specially constructed for the required purposes, or it may comprise a general-purpose computer selectively activated or reconfigured by a computer program stored within the computer. Such a computer program may be stored in a machine readable storage medium, such as, for example, any type of disk including floppy disks, optical disks, CD-ROMs, magnetic-optical disks, read-only memories (ROMs), random access memories (RAMs), EPROMs, EEPROMs, magnetic or optical card, or any type of media suitable for storing electronic instructions and coupled to a computer system bus.

The algorithms and displays presented and described herein are not inherently related to any particular computer or other apparatus or apparatuses. Various general-purpose systems may be used with programs in accordance with the teachings, or it may prove convenient to construct more specialized apparatus to perform the required method steps. The required structure for a variety of these systems will become readily apparent from the description alone. In addition, the present invention is not described with reference to any particular programming language, and accordingly, a variety of programming languages may be used to implement the teachings of the illustrated invention.

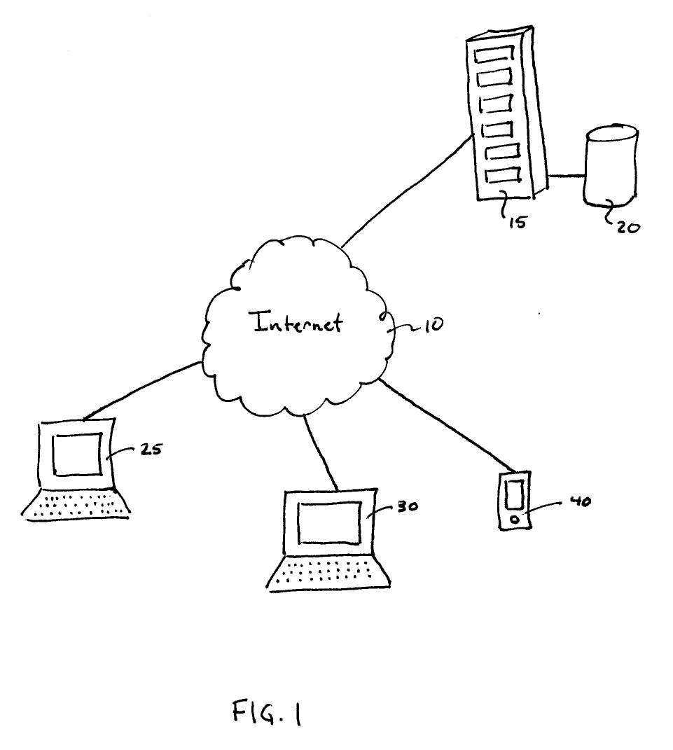

FIG. 1 is a schematic view of a typical hosting/access environment for implementing the present invention. In one embodiment, aspects of the present invention may be hosted on a server 15 coupled to a storage device 20. Typically, storage device 20 is a database configured to store multiple records of users of the website described herein. In one embodiment, the database is a secure database capable of storing information in accordance with privacy laws of the United States and countries that allow access to the website of the present invention. In most cases, Server 15 is coupled to Internet 10 so as to provide access to users of the site of the present invention. Users may access the website of the present invention in several different ways. In one embodiment, a user may use his or her personal computer or desktop computer 25 to access the information located on server 10. In another embodiment, a user may choose to use his or her PDA device or cell phone to access the information on server 15. In any event, any suitable device may be used to access server 15, including a direct connection not connected to Internet 15, so long as the connection is secure and able to receive information from the hosted website. In addition to a user of the website describer herein, a site administrator may access the server 15 through a remote access over the Internet 10 using a personal computer 30 or other secure device to remotely update website content.

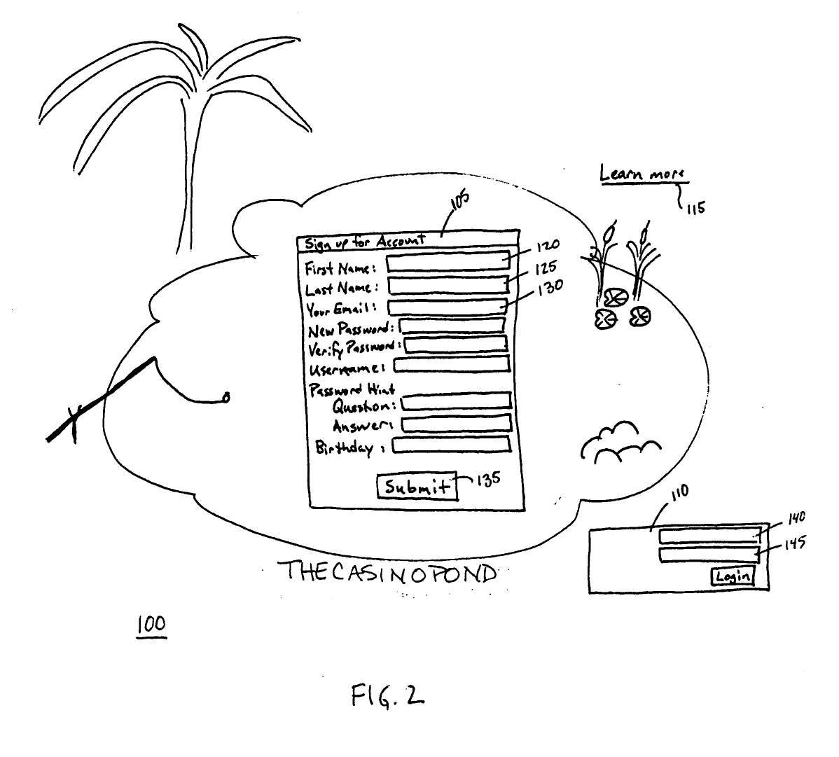

FIGS. 2 through 20 illustrate exemplary Web pages that may be provided or “served” by server 15 to one or more computers 25, 30 or PDA devices 40 to facilitate the environment of the present invention. It should be understood that many other appropriate Web pages may be provided in addition to or instead of the illustrated Web pages, which are provided only as examples. Appropriate modifications may be made to the content of the Web pages for transactions involving items other than the content illustrated and described with respect to FIGS. 2 through 20.

The operation present invention is divided into two user groups for purposes of illustrating and describing the various aspects of the operation of the website: individual users and casinos. Several of the figures and the associated description are devoted to the individual users of the content. An individual user is typically an individual with an interest in casino vacations, gaming discussions, on-line wagering, on-line gaming (both real money and for fun) and gaming content development. Several of the figures and the associated description are devoted to the casino operators who are interested in providing casino vacation packages to the individual users and reviewing gaming content submitted by developers. The following figures describe each unique user of the website of the present invention.

In addition, although Web pages are illustrated, similar scripts may be provided to an operator at a call center to facilitate the bid process. References below to a user selecting an option on a Web page may alternatively be performed in a telephone reservation situation by the user verbally selecting an option or using any other appropriate method, such as entering a touch tone digit using telephone.

### The Player Side of TheCasinoPond.com

FIG. 2 illustrates an exemplary splash page 100 returned when a user accesses the domain address of the present invention. In the illustrated embodiment, the user has accessed TheCasinoPond.com; however, one of ordinary skill in the art will appreciate that any domain name may be utilized without departing from the scope and spirit of the present invention. Any reference to TheCasinoPond.com is for illustrative purposes only and shall be generic to the description, and so any domain name may substituted without departing from the scope and spirit of the illustrated invention. In the illustrated embodiment, the user is either a returning member of the service or is a new member who needs to register prior to gaining access to the underlying content. In addition, the user may be an individual user or a casino operator. One of ordinary skill in the art will appreciate that the splash page 100 may be different for a user and a casino operator. For example, the casino operator may be given a secure portal to access the site or access to a completely different website that interacts with the individual users' website. The form is not important to the implementation of the present invention as long as the information is provided to the individual user and the casino operator in a manner that makes sense for purposes of maintaining the integrity and security of the data.

In the circumstances where the user is a new member, the user inputs personal information to gain access to the site. In the embodiment of the splash page 100 of FIG. 2, the site returns a pop-up menu 105 for the new user to sign up for an account with the site. Pop-up menu provides several fields 120, 125, 130 for example, that permit a user to enter information that the site will save and return a user name and password allowing access to the site. In the illustrated embodiment, the pop-up menu 105 requests that a new user enter his or her first name, last name, email address, password, user name, password hint and birthday to name a few. Some or all of this information may be required to obtain a username and password to enter the website; however, any such mandatory information is at the discretion of the site operator and in no means limits the present invention. It should also be apparent to one of ordinary skill in the art that this requested information is by no means exhaustive and may include additional information or the sign-up process may include more elaborate steps with multiple layers of approvals and clearances. The illustrated example, and the remaining web pages, illustrate one particular method of implementing the present invention but is by no means the only way.

Once the new user enters the requested information in the pop-up menu 105, he or she would mouse over and select the “Submit” button 135. The action of the user submitting the new user's information would start the process of granting access to the website of the present invention. In one embodiment, the information is transmitted to the server 15 over a secure connection on the Internet 10 to the administrator of the website. The administrator would then review the information provided by the user and determine if access to the website should be granted. If access is granted, the administrator would send an email to the email address provided by the new user indicating access to the website is granted. In another embodiment, the approval process is automated at the host level and would require no human interaction.

In the illustrated embodiment, returning users with a username and password and new users that have received their user name and password enter the website of the present invention through pop-up access menu 110. Typically, pop-up access menu 110 provides a username field 140 and a password field 145 for submitting the user's username and password, however, other information may be required to validate or confirm the user's identity as an added security level. Other checkboxes or hyperlinks may be provided, such as a checkbox for the option “Remember me” so that the user does not have to re-enter his or her username and/or password each time he or she returns to the website. Pop-up access menu 110 may also include a “Forgot my password” option or “Forgot my username” option. If such options are selected, the user answers a series of questions to either receive the information immediately or via the email address associated with the account.

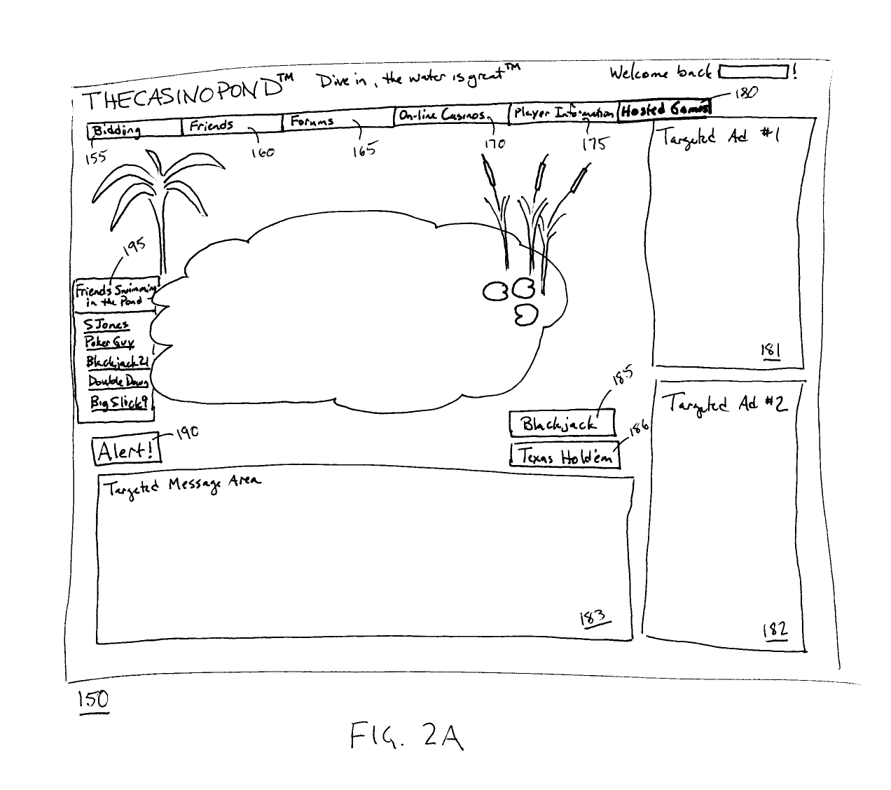

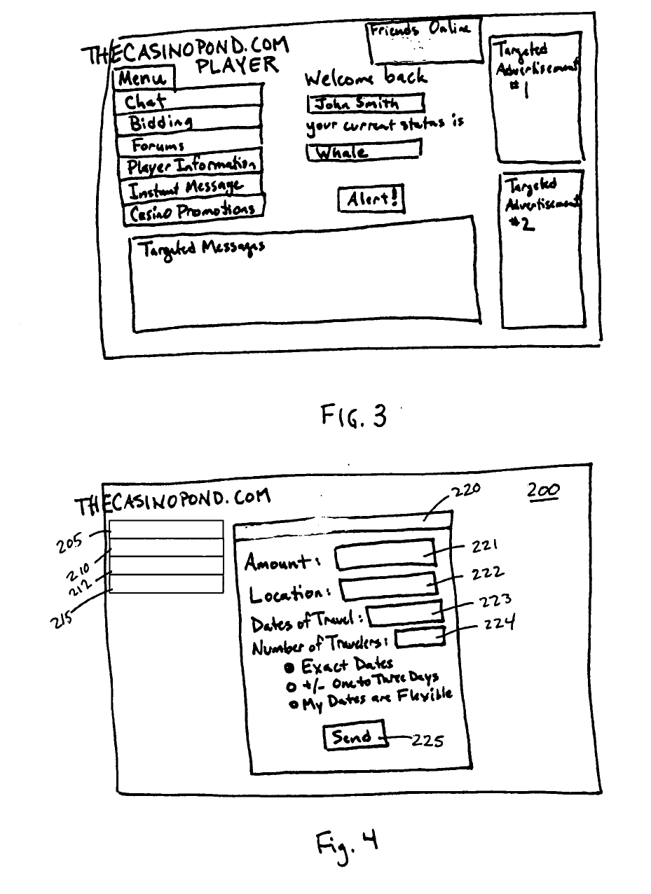

FIG. 2A illustrates an exemplary user home page 150 returned when the user successfully enters a valid username and password. In the illustrated example, several modules or sub-processes are associated with the main page, specifically, a bidding module 155, a friends module 160, a forums module 165, an on-line casino module 170, a player information module 175 and a hosted games module 180. Each module or sub-process is briefly described in FIGS. 4 through 9 that follow. FIG. 3 illustrates an alternate embodiment of the player home page of FIG. 2A. Additional drop down menus for underlying modules are provided in FIG. 3, such as a module for chat, instant messaging and casino promotions. Similar items will be described in FIGS. 4 through 9 for the various player modules associated with the underlying website TheCasinoPond.com.

Continuing with FIG. 2A, other information may be shown to the individual user in home page 150 of the TheCasinoPond.com website. For example, a plurality of targeted advertisements 181, 182 may be pushed to the user based upon any criteria available to the administrator of the website that is not in violation of any privacy laws. For example, such information may include the preferences entered initially, the player information entered after the user becomes a member and/or click-through operations by the user to other content from the website of the present invention to name a few. Home page 150 provides an area for targeted messages 183 to the individual user of the website. As an example, such targeted information may include a particular hosted game that was posted that may be of interest to the user, status on outstanding bids, on-line casinos that may be offering a particular promotion or tournament, or a notification that the user's comments left in a forum were responded to by others in the community. This list is not an exhaustive list and is intended to be an illustration of several types of targeted information that could be included in accordance with one aspect of the website of the present invention.

Home page 150 may also include a means for accessing the user's favorite gaming content. In the illustrated example, a blackjack button 185 and a Texas Hold'em button 186 are provided that, when selected, allow the user to play the selected game content. The game content may or may not be hosted by the website of the present invention. The buttons are typically selected by the user to be available on his or her main page of the website, however, the buttons of hyperlinks may be provided in response to the user's information or it may be provided automatically using an algorithm for determining the user's likes based upon his or her navigation through the modules of the website. In addition, home page 150 may provide an alert button or hyperlink 190 that returns a pop-up box with information, such as, for example, the acceptance of a bid by a casino. In the illustrated example, home page 150 provides a list of the user's friends who are currently on-line in box 195. In the illustrated embodiment, the friends' names are associated with a hyperlink that, if selected, returns an instant chat link for initiating a conversation with a friend in the community. FIG. 3 illustrates an alternate embodiment of the player home page of FIG. 2A. Additional drop down menus for underlying modules are provided in FIG. 3, such as a module for chat, instant messaging and casino promotions. Similar items will be described in FIGS. 4 through 9 for the various player modules associated with the underlying website TheCasinoPond.com.

The following discussion describes the various modules associated with TheCasinoPond.com. Other modules and processes may be used without departing from the scope and spirit of the present invention. In addition, the modules are illustrated and described in association with FIGS. 4 through 9, however, one of ordinary skill in the art will recognize that the form and presentation of the exemplary webpages are meant for illustration purposes only so as to describe the features and operation of the module itself and are not meant to be limiting in any way. Therefore, other methods, styles and/or systems for displaying information are intended to be captured within the broad concepts of the various modules of the present invention notwithstanding the fact that the chosen methods, styles and/or systems are not identical to those illustrated and described herein.

### Bidding Module

FIG. 4 illustrates an exemplary bidding page 200. Bidding page 200 may be communicated to the user's computer 25 or PDA 40 in response to a user selecting the bidding module 155 on the home page 150. In the illustrated embodiment of bidding menu 205, the user or player has the option of selecting make a bid 210, accept an offer 212 or review bids 215. The various selections are illustrated in the embodiment as shown, however, each option may be found in other modules or at other locations within the website community.

The bidding module 155 typically operates to match bids for vacations by individual users with vacation offers from casino operators. The casino operators' portion of the community associate with the website of the present invention will be illustrated and described in association with FIGS. 10 through 17. In operation, individual users provide information about their vacation requirements—which can range from the very general to the highly detailed depending upon the needs of the individual user—and submit the bid to the website for transmission to the casino operators. Vacation requirements may range from the must-haves to the I-wish-to-haves, with an appropriate box or the like provided to the individual user to select and indicate the appropriate strength of the user's vacation requirement. In another embodiment, players complete a “player profile” so that operators may tailor their offers to fit the information provided to increase their odds of striking a deal. It should be appreciated that any suitable bid information may be utilized in accordance with the make a bid module of TheCasinoPond.com website of the present invention without departing from the scope and spirit of the underlying core concept.

Once submitted to the website, additional information about the individual user may also be made available to the casino operator, such as their player rating in the community based upon how much money the player has wagered at casinos in the past, a player rating based upon how much money the player has spent on non-gaming activities at casino properties in the past (e.g., shops, clubs, restaurants, etc.), a player rating given by casino operators as to the truthfulness of the individual user's information and bidding history, and verified funds in an account to be transferred to the casino property upon acceptance of a bid to name a few. In one embodiment, the information associated with the individual user is automatically transferred to the casino operator upon submission of a bid by the individual user. In another embodiment, the information must be requested and only will be transferred if certain privacy criteria are met by the casino operators.

In the current embodiment of the bidding page 200, the user selects the make a bid option 210 from the bidding menu 205. The make a bid option 210 of the present invention is associated with an individual user or player in the community submitting gambling vacation information for review by a supply side user, in this case a casino operator, in offering gambling vacation packages in accordance with the casino operator's ability and desire to satisfy the individual user's vacation requirements. In response, the system returns a make a bid pop-up menu 220 giving the user a few fields to submit in formation. In the illustrated embodiment, the use inputs the amount of the bid in an amount field 221, the location of the trip in the location field 222, the dates of travel for the vacation in date field 223 and the number of travelers in the number field 224. Additional individual user fields associated with making a bid on a gambling vacation may be used that are not currently illustrated, such as selection of particular casino properties associated with a location, desired on-property restaurants, and desired on-site amenities to name a few.

One of ordinary skill in the art will appreciate that the make a bid section may also include a non-gambling trip for a player who is rated in the community. For example, a player with a whale rating may desire a vacation for a bachelor party where gambling is an afterthought. In such cases, the whale player will bid on a vacation that includes comps at clubs, restaurants, golf, and bars to name a few. The players gambling rating may then secure comps at a casino property in the hopes that the player will return at a later date for gambling. In another embodiment, the whale player may have a separate rating based upon money spent on non-gambling activities.

The vacation requirements may be as narrow or as general as the individual user desires in accordance with the particular menu items offered by the website. In the illustrated example, the individual user is also able to select whether the dates of travel must be exact, can vary by plus or minus one to three days, or the user is flexible as to the dates of travel. Limiting or broadening choices such as the selections shown in FIG. 4 may increase or decrease the number of offers returned to the individual user.

Once the information is entered into the make a bid menu 220, the individual user selects the send option 225 to submit the bid to TheCasinoPond.com website. The individual user's bid information is thereafter stored, preferably in the database 20 associated with host server 15, with the ability to manipulate the data given to the administrator of the website so as to display it to the individual user for purposes of review or the casino operator in the form of a bid.

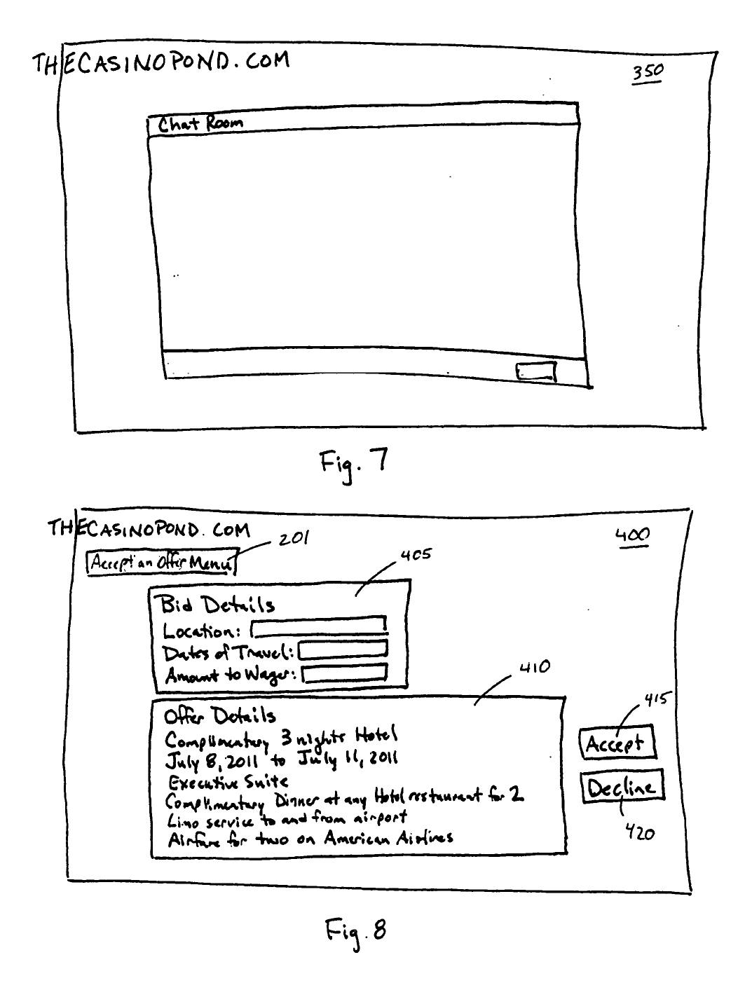

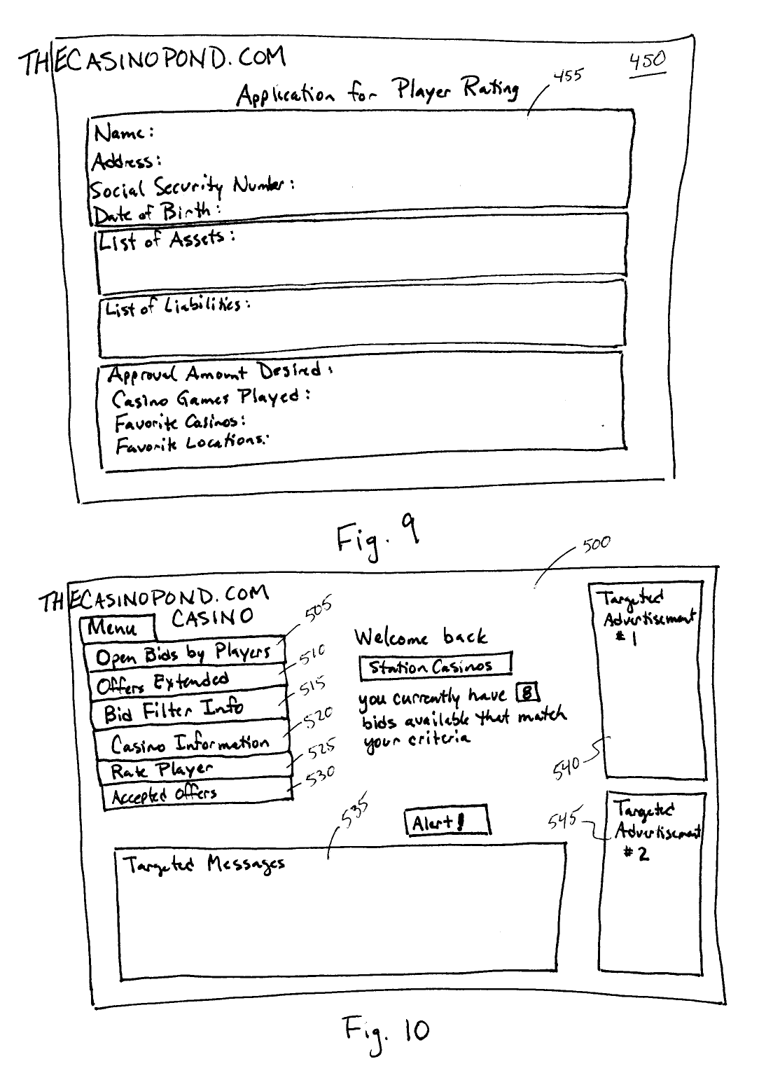

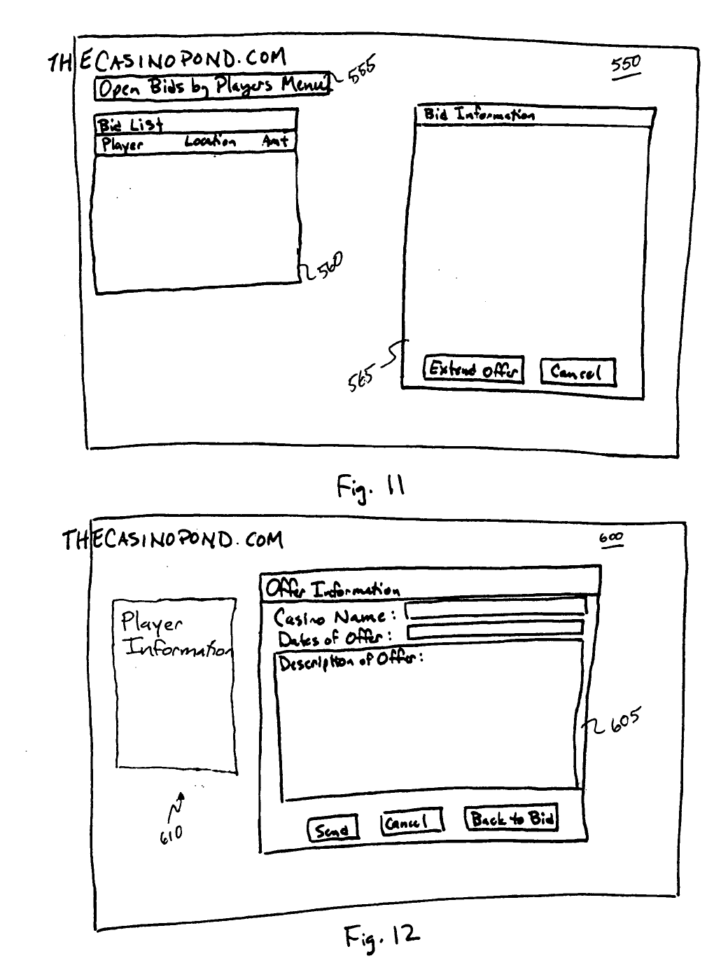

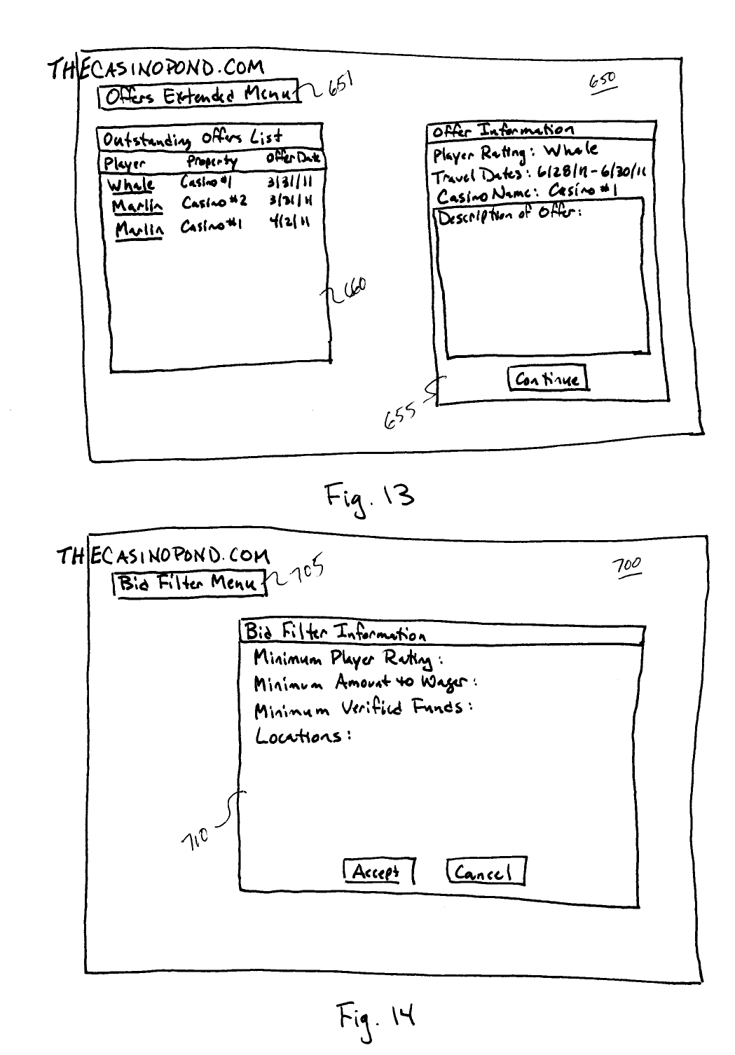

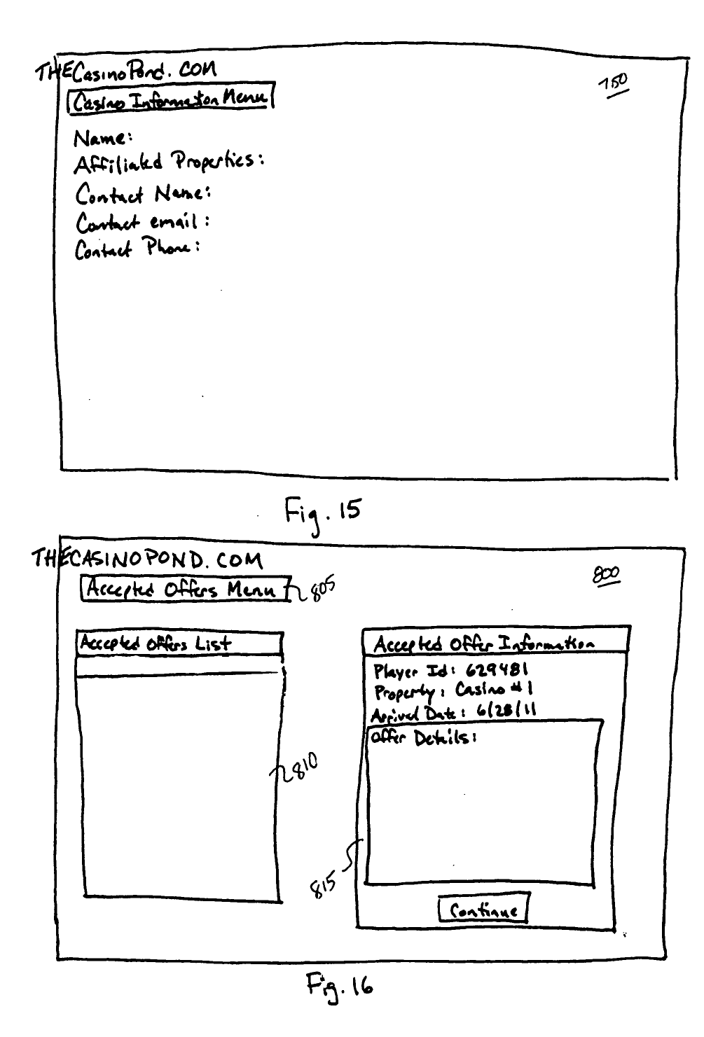

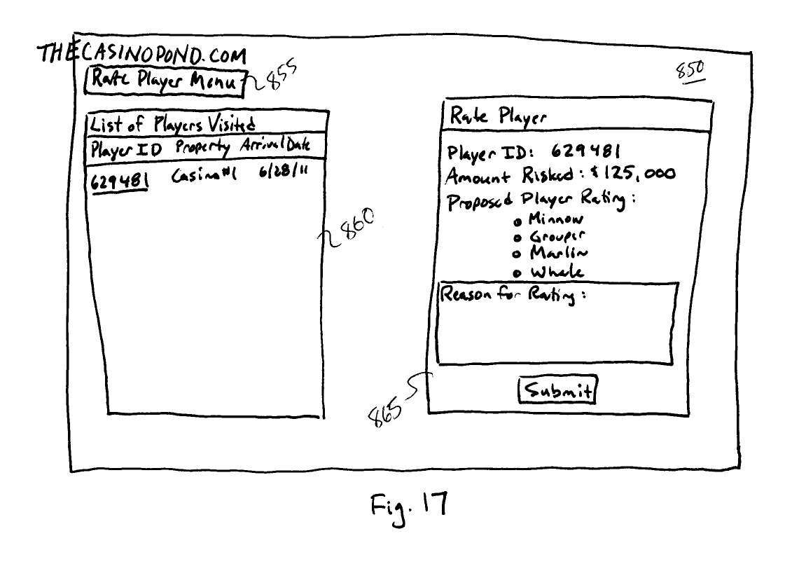

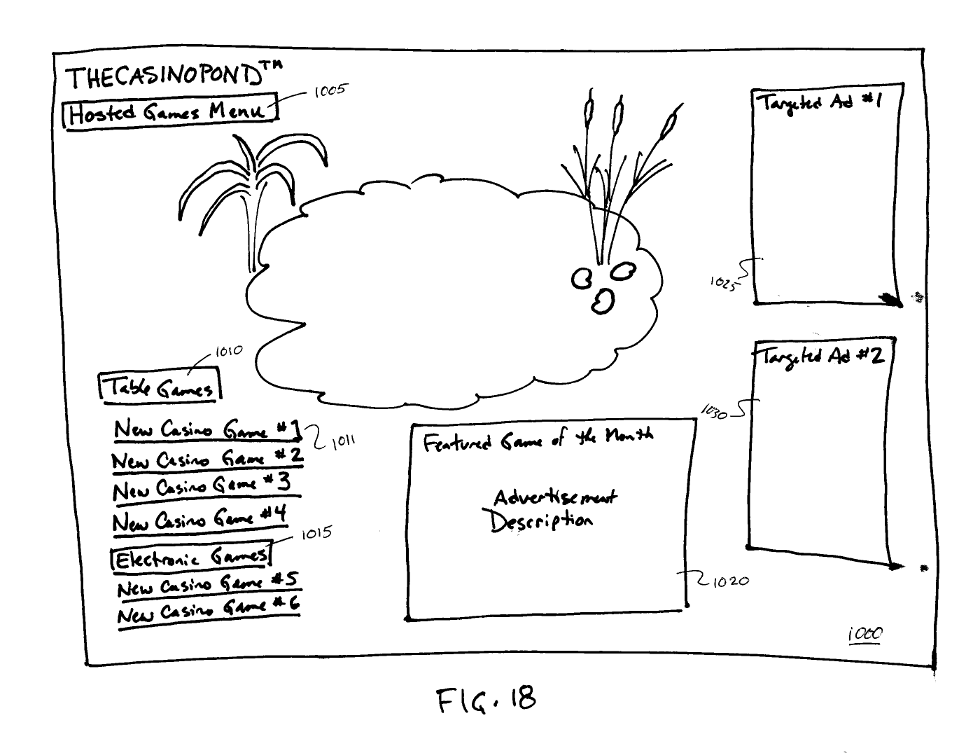

If a casino property responds to a bid with an offer, as illustrated and described with respect to FIGS. 10-17, the individual is notified of the availability of an offer by a casino property, preferably on the home page 150 that the user sees when he or she logs into TheCasinoPond.com website. FIG. 8 illustrates an exemplary accept an offer page 400. The accept an offer page 400 may be communicated to the user's computer 25 or PDA 40 in response to an individual user selecting the bidding module 155 on the home page 150. In the illustrated embodiment of the accept an offer menu 201, the individual user or player is shown a bid space 405 that provides the bid details he or she submitted for bid. In the illustrated example, the bid details include the location of travel, the dates of travel and the amount the individual user intends to wager at the casino property. Also displayed with the bid space 405 is the corresponding offer space 410 that provides the offer details from the casino property including, for example, any casino hotel accommodations, meals, airline tickets, and transportation. The individual user is then given the option of accepting or declining the offer using an accept button 415 or a decline button 420.

Additional processes may be provided for an accepted offer, such as the provision of a credit card number, an authorization to release funds to the casino property, and a release of personal information authorization for the transfer of information from TheCasinoPond.com website to the casino operator to name a few. Additional processes may be provided for a declined offer such as a questionnaire from the property to determine why the offer may have been rejected and a follow-up screen that may ask if there are additional requests (counter-offer) to submit to the casino that may change the decline to an accept to name a few.

### Player Information Module

FIG. 5 illustrates an exemplary player information page 250. Player information page 250 may be communicated to the user's computer 25 or PDA 40 in response to an individual user selecting the player information module 175 on the home page 150. In the illustrated embodiment of player information menu 255, the individual user or player has the option of viewing community and individualized information associated with the username, inputting certain information to be associated with the username, and selecting certain options that are associated with a third-party website to name a few. For example, the player information menu 255 in FIG. 5 shows the name associated with the username in the name field 265, the status of the user in the status field 266 and the approval amount associated with the approval field 267. In the illustrated example, the information in the name field 265, status field 266 and approval field 267 are pushed from the server 15 by the website, such as TheCasinoPond.com, and are read only fields.

The individual user is able to select other options, such as applying for a player rewards card 270, applying for a players rating 275 (which is illustrated and described with respect to FIG. 9 herein), and manually searching for and adding friends to the individual user's friend list 280. Certain options, such as applying for a players card or applying for a player rating, may be performed by the host website or may be performed by a third-party website either independently or at the direction of the host website.

In the embodiment shown in FIG. 5, the player information module 175 also displays the current outstanding bids that the individual user has submitted in an outstanding bid list 260. The information in outstanding bid list 260 is pushed from the server 15, which had previously stored the information when it was entered by the individual user in the make a bid module described previously. The individual bids 261, 262, 263 may be selectable by the user as a hyperlink so as to return the underlying bid information for each in a separate window or a pop-up window (not shown). Additional statistical information about the individual user may be shown in statistical data field 285, such as trips accepted, amount of money wagered per trip and number of forum postings to name a few. The statistical data field 285 is helpful tool and may be used in any way the system administrator considers necessary or useful to assist the individual user in utilizing the website of the present invention.

FIG. 9 illustrates an exemplary application for player rating page 450. Application for player rating page 450 may be filled out by the individual user and communicated from the user's computer 25 or PDA 40 to the host server 15 (and stored in database 20). In the illustrated example, the application for player rating request 455 provides a plurality of fields for the individual user to enter information, such as name, address, social security number, date of birth, assets, liabilities, approval amount desired, casino games played, favorite casinos and favorite locations to list a few examples. A few examples of player ratings in TheCasinoPond.com website—based upon an algorithm that takes into account how much the user typically wagers at a casino and how much the player is approved for based upon his or her application—include whale, marlin, grouper and whale, however, any number of player ratings and associated names may be used and still fall within what was intended by the present application.

### Forums Module

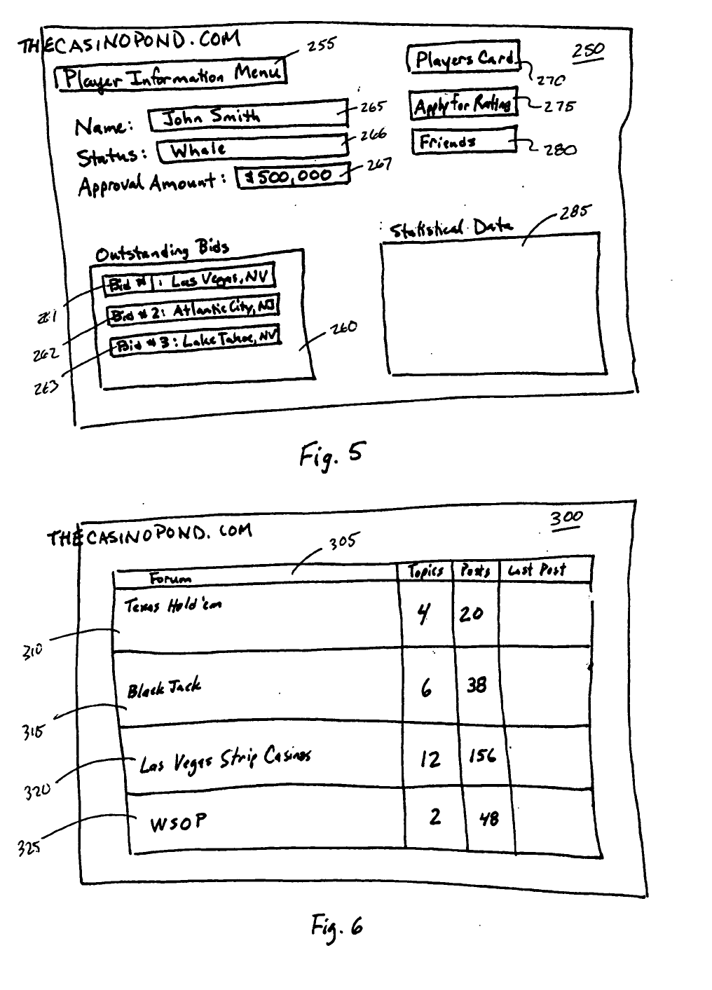

FIG. 6 illustrates an exemplary forum page 300. Forum page 300 may be communicated to the user's computer 25 or PDA 40 in response to a user selecting the forums module 165 on the home page 150. In the illustrated embodiment of forum menu 305, the host website or systems administrator has the ability to create a number of user forums directed to topics that would interest the individual users in TheCasinoPond.com community. In the illustrated example, a Texas Hold'em forum 310, a Blackjack forum 315, a Las Vegas Strip Casinos forum 320 and a WSOP® forum 325 are shown as being created by the community for use by the individual users. One of ordinary skill in the art will appreciate that any number of forums and sub-forums may be created without departing from the scope and spirit of the present invention. The illustrated forums of FIG. 6 show additional information such as the number of topics (or sub-forums), the number of posts within the forum and the last post including the time and username of the individual user posting to the forum, which are in no way inclusive of the nature of information that may be displayed. Within each forum, individual users may post questions, comments, information, feedback and any other helpful material under the various topics and subtopics to be shared with other individual users in the community.

FIG. 7 illustrates an exemplary chat room page 350. Chat room page 350 may be communicated to the user's computer 25 or PDA 40 in response to a user selecting the chat option from anywhere in the website, including the forum area. In one embodiment, the chat room page 350 may be associated with particular forum topics, such as Texas Hold'em 310. In operation, the Texas Hold'em forum 310 provides an option to select the Texas Hold'em chat room. The chat room is illustrated as a typical chat setting having the ability to see the most recent dialogue and submit text to the conversation with one or more individual users who are in the chat room environment.

### Friends Module

A friends module for the website of the present invention allows the individual users to search, add and view friends from TheCasinoPond.com community. In one aspect of the invention, the individual user may click on the hyperlink of another user in the community to add the user to his or her friend list. In the friends module, the individual user may be able to search for friends in the community, by the underlying name associated with the username or some other criteria, and manually add the friend to his or her friend list. In addition to the ability to manually search for friends and add them to a friend list, the friend module provides the individual user with a current friend list.

### On-Line Casinos Module

TheCasinoPond.com website offers a portal to on-line casinos through the online casinos module 170 from the main page 150. In operation, the website of the present invention returns a list of approved on-line gaming sites when a user selects the Online Casinos Module 170, typically as a plurality of drop-down menu items. If selected, the individual user is transferred from TheCasinoPond.com website to the third party website of the on-line casino. TheCasinoPond.com is paid a fee for each user that clicks through to an on-line casino website, which may be separated by those who stay and play and those who just look and leave.

### The Casino Side of TheCasinoPond.com

FIG. 10 illustrates an exemplary casino home page 500 returned when the casino operator successfully enters a valid username and password. In the illustrated example, several modules or sub-processes are associated with the main page, specifically, open bids by player module 505, an offers extended module 510, a bid filter module 515, a casino information module 520, a rate player module 525 and an accepted offers module 530. Each module or sub-process is briefly described in FIGS. 11 through 17 that follow.

Casino home page 500 provides an area for targeted messages 535 to the casino operators associated with the website. As an example, such targeted information may include a particular hosted game that was posted to TheCasinoPond.com that may be of interest to the casino operator, status on outstanding offers, statistics on membership, and specific bids that may be of interest to name a few examples. This list is not an exhaustive list and is intended to be an illustration of several types of targeted information that could be included in accordance with one aspect of the website of the present invention. Other information may be shown to the casino operator in casino home page 500 of the TheCasinoPond.com website. For example, a plurality of targeted advertisements 540, 545 may be pushed to the casino operator based upon any criteria available to the administrator of the website that is not in violation of any privacy laws. For example, such information may include the preferences entered initially by the casino, the information entered after the casino becomes a member of the website community and/or click-through operations by the casino operator to other content from the website of the present invention to name a few.

### Open Bids by Player Module

FIG. 11 illustrates an exemplary open bids by players page 550. Open bids page 550 may be communicated to the casino operator's computer 25 or PDA 40 in response to an operator selecting the open bids by player module 505 on the home page 500. In the illustrated embodiment of open bids menu 555, a bid list 560 is displayed to the casino operator. The bid list 560 contains all open bids (before bid filtering) from users in TheCasinoPond.com website community. In the illustrated embodiment, the information supplied to the casino operator includes the player rating (i.e., Whale, Marlin, Grouper and Minnow in the example), the location of the user's vacation and the amount the user is willing to wager on his or her gambling vacation. The identity of the username is maintained in secrecy to protect the integrity of the bidding process. Each player's status is a hyperlink, which returns the details of the bid when selected.

In the illustrated example, the casino operator selects the hyperlink of the first player in the bid list, i.e., the Whale who wants to travel to Las Vegas and wager $150,000. In response, the system returns the detailed bid information 565. Detailed bid information 565 provides the casino operator with the player rating, the exact travel dates, the amount the player will wager or put at risk, the amount of verified funds, the location of the player's vacation, the casino games the player plays and any special requests. After reviewing the information, the casino operator may choose to extend an offer to the anonymous player or cancel the current view, which simply removes the bid information pop-up menu from view. In another embodiment, the bid information may be displayed in a new window. If the casino operator chooses to extend an offer, a new page 600 is displayed that provides the fields for an offer.

FIG. 12 illustrates an exemplary offer page 600 for a casino operator to submit an offer to an open bid from a user. Offer page 600 may be communicated to the casino operator's computer 25 or PDA 40 in response to the operator selecting the extend offer option in the bid information 565 of the open bids page 550. The bid information 610, corresponding to the detailed bid information 565 in the open bids page 550, is displayed next to the offer information menu 605 for reference and to allow the casino operator to tailor the offer information to the bid details. In the illustrated embodiment, the casino operator enters the casino name, the dates of the offer and the description of the offer. The casino operator then submits the bid to TheCasinoPond.com if he or she is satisfied with the terms of the offer and intends to submit an offer for the particular anonymous user. At any point prior to submission of the offer, the casino operator may cancel the transaction or return to the open bids page 550. In operation, upon submission of the offer, the website host transmits the offer to the anonymous user for processing.

### Offers Extended Module

FIG. 13 illustrates an exemplary offers extended page 650. Offers extended page 650 may be communicated to the casino operator's computer 25 or PDA 40 in response to an operator selecting the offers extended module 510 on the home page 500. The offers extended menu 651 displays the outstanding offers list 660 associated with the casino operator. The offers are listed in the offers list 660 by player rating, the casino property associated with the offer and the offer date. The player rating indicator is a hyperlink that displays the underlying data when selected. In the illustrated embodiment, the offer information associated with the “Whale” is displayed in pop-up menu 655.

### Bid Filter Module

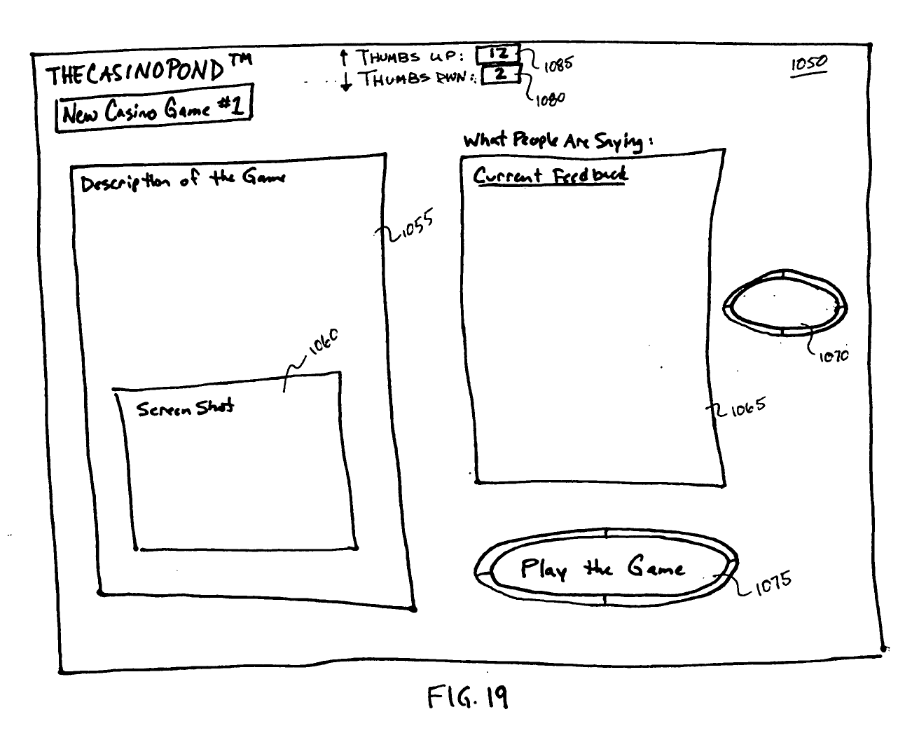

FIG. 14 illustrates an exemplary bid filter page 700. Bid filters page 700 may be communicated to the casino operator's computer 25 or PDA 40 in response to an operator selecting the bid filters module 515 on the home page 500. The bid filter menu 705 displays a pop-up menu 710 with fields for filtering the bid list 560 in the open bids by players menu 555. In the illustrated example, the casino operator can filter the player bids by a minimum player rating, a minimum amount that the player has agreed to place at risk, minimum verified funds and locations to name a few. Other filter options are contemplated within the scope and spirit of the present invention. Selecting the accept button in pop-up menu 705 filters the player bids in the bid list according to the selected criteria. The casino operator may cancel the bid filter criteria at any time.

### Casino Information Module

FIG. 15 illustrates an exemplary casino information page 750. Casino information page 750 may be communicated to the casino operator's computer 25 or PDA 40 in response to the operator selecting the casino information module 520 on the home page 500. The casino information menu displays the fields for inputting data into the system. In the illustrated example, a casino operator enters the name of the casino, any affiliated properties, a contact name, a contact email address and a contact phone number to name a few examples. Once saved, TheCasinoPond.com website has access to the information and may utilize it within the boundaries of the privacy laws of the relevant jurisdictions.

### An Accepted Offers Module

FIG. 16 illustrates an exemplary accepted offers page 800. Accepted offers page 800 may be communicated to the casino operator's computer 25 or PDA 40 in response to the operator selecting the accepted offers module 530 on the home page 500. The accepted offers menu 805 displays the accepted offers list 810 associated with the casino operator. The accepted offers are listed in the offers list 810 by unique player ID, the casino property associated with the accepted offer and the arrival date. The player ID indicator is a hyperlink that displays the underlying data when selected. In the illustrated embodiment, the accepted offer information associated with Player ID #629481 is displayed in pop-up menu 815.

### Rate Player Module

FIG. 17 illustrates an exemplary rate player page 850. Rate player page 850 may be communicated to the casino operator's computer 25 or PDA 40 in response to the operator selecting the rate player module 525 on the home page 500. The rate player menu 855 displays the list of players visited 860 associated with the casino operator. The players who have visited the casino operator's property are listed in the list 860 by unique player ID, the casino property associated with the visit and the arrival date. The player ID indicator is a hyperlink that displays the rate player menu 865 for a casino operator to enter data for purposes of rating a player in TheCasinoPond.com community. In the illustrated embodiment, the casino operator is given the amount risked at the operator's property and provides a proposed player rating and a reason for the rating prior to submission. In operation, upon submission, the host website may perform an algorithm to calculate or recalculate a player's rating in TheCasinoPond.com community.

Hosted Games of TheCasinoPond.com

FIGS. 18 through 20 disclose one embodiment of a typical hosted games module of TheCasinoPond.com website. The hosted games module provides a location for gaming content developers to post a working model of their table games to the website community and have their games played and reviewed by the individual users of the community. Casino operators also have access to the hosted games and the reviews as well as additional information from the website provider such as number of hits and average length of play, which may assist them in making a decision regarding the placement of a particular game in one of their casino properties. In operation, a gaming content developer pays a fee to the host website (TheCasinoPond.com in the current example) for the development of the marketing materials, the calculation of the math associated with the gaming content (such as hold percentages, hands per hour, etc.), and the development of a working digital version of the game—typically programmed in Adobe® Flash®, but programmable in other languages supported by the operating system of the particular website. The digital version of the gaming content will be hosted online exclusively by TheCasinoPond.com website and therefore, will be available for play and comment by the members of the community. If a hosted game is purchased by a casino operator, the host website receives a percentage of the monthly rate for the game placement plus any expenses such as marketing, math calculations and administrative costs.

FIG. 18 illustrates an exemplary hosted games page 1000. Hosted games page 1000 may be communicated to a computer 25 or PDA 40 from server 15 in response to an individual user, a casino operator or a gaming content developer selecting a hosted games module on a home page. In the illustrated embodiment of hosted games menu 1000, the hosted table games list 1010 and the hosted electronic games list 1015 are provided, which list both the table game content and electronic game content that are currently available to the users in the website community for play and feedback. Hosted game page 1000 also provides a space for a featured game of the month 1020. For a fee, a game developer may request that the website host show a description of his or her game for every member of the website community who clicks on the hosted games module 180. Hosted game page 1000 includes targeted advertisements 1025, 1030 for pushing ads to the user based upon, for example, the user's profile, likes and habits.

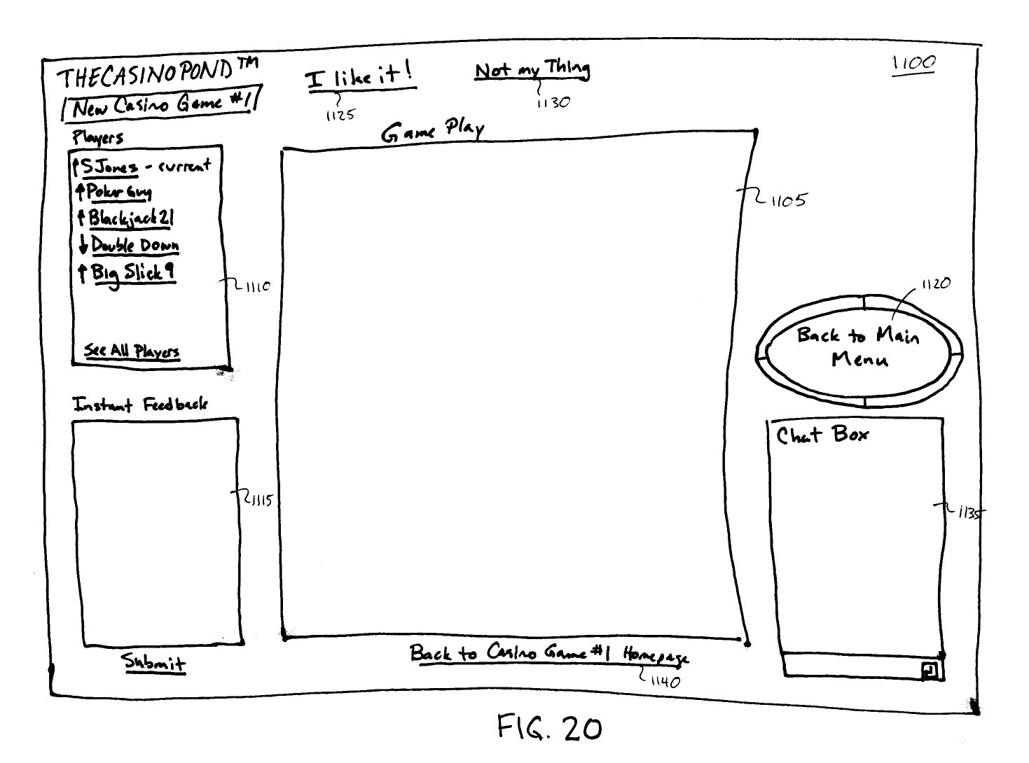

Typically, the individual games listed under each category are associated with a hyperlink that delivers the user a new page that hosts the particular hosted game. In the illustrated embodiment, for example, selecting the hyperlink 1011 associated with New Casino Game #1 opens a new web page 1050 dedicated to the game content and associated feedback associated with that particular hosted game. FIG. 19 illustrates an exemplary Game #1 hosted game page 1050 for the gaming content associated with New Casino Game #1. Game #1 hosted game page 1050 may be communicated to the user's computer 25 or PDA 40 in response to a user selecting the hyperlink 1011 on the hosted games menu 1005 of the hosted games page 1000. In the illustrated embodiment of Game #1 hosted game page 1050, the user or player is provided with a description of the game 1055, which may or may not include screen shots 1060, and a list of the current feedback for the game 1065 starting with the most recent postings. Game #1 hosted game page 1050 includes a quick view of the “thumbs up” and “thumbs down” ratings of the game, which will be illustrated and described with regards to FIG. 20.

If the user has already played the game content, he or she may select the provide feedback button 1070 to post comments about the game to the current feedback list 1065. In the illustrated embodiment, if the user is interested in playing the game, he or she selects the play the game button 1075, which opens a new web page 1100 dedicated to the playable digital version of the game 1105 and other options.

FIG. 20 illustrates a game play web page 1100. Game play page 1100 may be communicated to a computer 25 or PDA 40 from server 15 in response to an individual user selecting the play the game option 1075 in the Game #1 hosted game page 1050. Game play page includes the digital version of New Casino Game #1 as a playable Adobe® Flash® game 1105. The user may play the game as it would appear on the floor of a casino property; however, real money is not wagered. In addition, the game play page includes a space 1110 that indicates the players who have played and are currently playing the playable game 1105. Each of the players in the player list 1110 is a hyperlink that attempts to institute an instant chat session in chat box 1135. The instant chat session may be ignored or accepted by the user associated with the displayed username. In another embodiment, the hyperlink may be configured to send an email to the email account associated with the user shown in the player list 1110.

In the illustrated embodiment, game play page 1100 includes an instant feedback option 1115, where a user can provide comments, suggestions and/or fixes that, when submitted, are transmitted to the current feedback section 1065 of the Game #1 hosted game page 1050. In addition to feedback, the user may provide feedback in the form of a quick response. The user may click on the hyperlink representing the quick response choice “I like it!” 1125 or the hyperlink representing the quick response choice “Not my thing” 1130, which transmits the user's quick response to the website host and is subsequently displayed in the Game #1 hosted game page 1050 as a thumbs up 1085 or a thumbs down 1080. In the illustrated embodiment, only the total number of users that select either quick response 1125, 1130 will be shown—there are no usernames or comments associated with the displaying of the quick response total. A user may return to the hosted game main page 1000 having the list of all hosted game content by selecting button 1120 or return to the game page of the current casino game 1050 by selecting hyperlink 1140.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as the invention.

I claim:

1. A computer implemented method for matching individual players and casino operators, said method comprising:
providing a computer generated interface for individual players;
storing information associated with said individual players in memory;
providing a computer generated interface for casino operators;
storing information associated with said casino operators in memory;
providing a computer generated interface for an individual player to make a bid on a gambling vacation;
transmitting said bid to a central processing unit and storing said bid in memory;
retrieving said bid from memory and providing said bid to a casino operator;
providing a computer generated interface for a casino operator to make an offer in response to said bid;
transmitting said offer to a central processing unit and storing said bid in memory; and
providing said offer to said individual player.

2. A computer implemented method for hosting gaming content from a game developer, said method comprising:
creating a digital version of a casino table game;
providing said digital version of a table game to an on-line community of individual players and casino operators;
receiving feedback of said digital version of a table game; and
providing said feedback, a mathematical calculation associated with the gaming content, and marketing materials to said game developer in return for a fee.
